(19) United States
(12) Patent Application Publication
(10) Pub. No.: US 2026/0118622 A1
(43) Pub. Date: Apr. 30, 2026

(54) CAMERA PROTECTION FROM EXTERNAL HAZARDS

(71) Applicant: Meta Platforms Technologies, LLC, Menlo Park, CA (US)

(72) Inventors: LIDU HUANG, Danville, CA (US); Jiger Patel, San Jose, CA (US); Jack Diepen Mumbo, Beaverton, OR (US); HUI LI, San Jose, CA (US); Karen Harban, Bothell, WA (US); Jang Ryul Yoon, San Jose, CA (US); Alan Kleiman Shwarsctein, Saratoga, CA (US); Shay Hamer, Sunnyvale, CA (US); Ming Xu, Sammamish, WA (US); Ying Zhou, Cupertino, CA (US); Adar Magen, Sunnyvale, CA (US); Michael Andrew Brookmire, Redwood City, CA (US); Jeremiah Nyaribo, Palo Alto, CA (US); Linsen Bie, San Francisco, CA (US); Yizhi Xiong, Foster City, CA (US); Animesh Banerjee, San Jose, CA (US); Arsenio de Guzman, San Jose, CA (US); Zachary Ian Howard, San Francisco, CA (US); Ji Shern Tan, Fremont, CA (US); Phaninder Kanikella, Sunnyvale, CA (US)

(21) Appl. No.: 19/307,300

(22) Filed: Aug. 22, 2025

Related U.S. Application Data
(60) Provisional application No. 63/714,059, filed on Oct. 30, 2024.

(51) Int. Cl. G02B 7/02; G02C 11/00

(52) U.S. Cl. CPC G02B 7/021; G02C 11/10

(57) ABSTRACT

Examples of camera protections from external hazards are described. A sheath may surround a lens barrel to protect a camera module from external hazards. A passivation layer may be formed on a lens barrel or a sheath to protect the lens barrel. A suspension bracket that provides impact absorption may be included in a camera module.

### CROSS-REFERENCE TO RELATED APPLICATIONS

This application claims priority to U.S. provisional Application No. 63/714,059 filed Oct. 30, 2024, which is hereby incorporated by reference.

### TECHNICAL FIELD

This disclosure relates generally to optics and in particular to cameras.

### BACKGROUND INFORMATION

Cameras on consumer devices are vulnerable to environmental hazards that can compromise their performance and longevity. Drops can cause lens misalignment or damage to internal mechanics, for example. Additionally, exposure to contaminants like dust, sand, or liquids can infiltrate the housing of the camera and cause damage to the optics or electronics. When cameras are included in wearable devices, the desire for protection from external hazards may increase.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates a head-mounted device that includes one or more cameras, in accordance with aspects of the present disclosure.

FIG. 1B illustrates a zoomed in view of an exposed camera that is protruding out from a frame of head-mounted device, in accordance with aspects of the disclosure.

FIGS. 2A-2D illustrate a lens configured to focus image light to an image sensor and a lens barrel with a sheath, in accordance with aspects of the disclosure.

FIG. 3A illustrates a sheath for a lens barrel, in accordance with aspects of the disclosure.

FIG. 3B illustrates a camera module having a sheath and a lens barrel, in accordance with aspects of the disclosure.

FIG. 4A illustrates a portion of a camera module that includes a lens barrel molded to a sheath, in accordance with aspects of the disclosure.

FIG. 4B illustrates a portion of a camera module that includes a lens barrel, a sheath, and elastomer layer, in accordance with aspects of the disclosure.

FIG. 4C illustrates a portion of a camera module that includes a lens barrel molded to a sheath that includes features, in accordance with aspects of the disclosure.

FIG. 4D illustrates a portion of a camera module that includes a lens barrel molded to a sheath that includes features that are considered threads disposed on the inside wall of the sheath, in accordance with aspects of the disclosure.

FIGS. 4E and 4F illustrate features that may also function as impact distribution features to distribute impact received by the respective sheaths downward around the respective lens barrel, in accordance with aspects of the disclosure.

FIG. 4G illustrates a top view of an example adhesive placement with respect to a sheath and a lens barrel, in accordance with aspects of the disclosure.

FIG. 5A illustrates a camera module including an image sensor and a polycarbonate camera barrel configured to secure one or more lenses to focus image light to an image sensor, in accordance with aspects of the disclosure.

FIG. 5B illustrates a camera module where a passivation layer is disposed on a top portion of a lens barrel and on a portion of the sides of the lens barrel, in accordance with aspects of the disclosure.

FIG. 5C illustrates an image of a lens barrel that is partially covered by a passivation layer, in accordance with aspects of the disclosure.

FIG. 6 illustrates a frame and a portion of a camera situated in a frame recess, in accordance with aspects of the disclosure.

FIG. 7A illustrates an exploded view of an example camera module that dampens the force of impacts sustained by camera, in accordance with aspects of the disclosure.

FIG. 7B illustrates a zoomed-in view of an example suspension bracket and a camera, in accordance with aspects of the disclosure.

FIG. 8 illustrates an example camera module soft-mounted into a frame, in accordance with aspects of the disclosure.

FIG. 9A illustrates a top-perspective view of an example insert that includes a frame plane and alignment features, in accordance with aspects of the disclosure.

FIG. 9B illustrates a side view of an insert, in accordance with aspects of the disclosure.

FIG. 9C illustrates a bottom-perspective view of an example insert that includes an overmolded seal, in accordance with aspects of the disclosure.

### DETAILED DESCRIPTION

Embodiments of camera protections from external hazards are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

The disclosure includes camera protections from external hazards such as protection from the impact of drop events and protection from external contaminants.

Traditionally, camera barrels are not exposed in consumer electronic devices. Instead, an outside structure (e.g. plastic shell) or coverglass usually protects the camera barrels from an outside environment of the device. Thus, chemical degradation in camera barrels has not previously been problematic. Camera barrels are often made out or Polycarbonate (PC). Polycarbonate is known to be prone to chemical degradation, however other thermoplastics can also have similar performance degradation. The outside environment may include exposure to sunscreen, bug repellant, or other skincare products that may subject the camera barrel to chemical degradation, for example. Thus, exposed PC in a camera barrel may cause a device to fail one of the stringent chemical testing that is part of reliability testing.

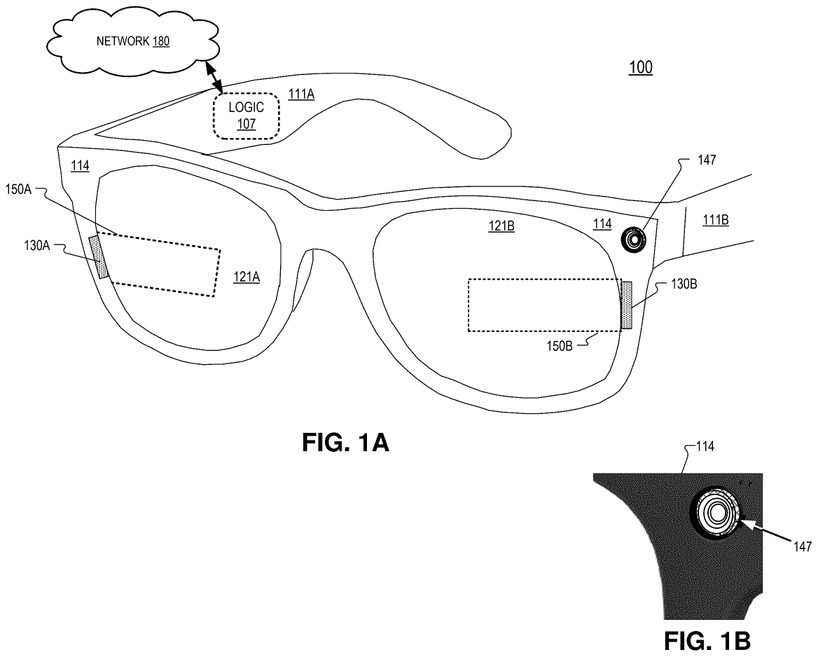

FIG. 1A illustrates a head-mounted device 100 that includes one or more cameras 147, in accordance with aspects of the present disclosure. Head-mounted device 100 includes frame 114 coupled to arms 111A and 111B. Lens assemblies 121A and 121B are mounted to frame 114. Lens assemblies 121A and 121B may include a prescription lenses matched to a particular user of head-mounted device 100. The illustrated head-mounted device 100 is configured to be worn on or about a head of a wearer of head-mounted device 100.

In the head-mounted device 100 illustrated in FIG. 1A, each lens assembly 121A/121B includes a waveguide 150A/150B to direct image light generated by displays 130A/130B to an eyebox area for viewing by a user of head-mounted device 100. Displays 130A/130B may include a beam-scanning display or a liquid crystal on silicon (LCOS) display for directing image light to a wearer of head-mounted device 100 to present virtual images, for example. Hence, head-mounted device 100 may be considered a head-mounted display (HMD).

Lens assemblies 121A and 121B may appear transparent to a user to facilitate augmented reality or mixed reality to enable a user to view scene light from the environment around them while also receiving image light directed to their eye(s) by, for example, waveguides 150. Lens assemblies 121A and 121B may include two or more optical layers for different functionalities such as display, eye-tracking, and optical power. In some embodiments, image light from display 130A or 130B is only directed into one eye of the wearer of head-mounted device 100. In an embodiment, both displays 130A and 130B are used to direct image light into waveguides 150A and 150B, respectively. The implementations of the disclosure may also be used in head-mounted devices (e.g. smartglasses) that don't necessarily include a display but are configured to be worn on or about a head of a wearer.

Frame 114 and arms 111 may include supporting hardware of head-mounted device 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, head-mounted device 100 may be configured to receive wired power. In one embodiment, head-mounted device 100 is configured to be powered by one or more batteries. In one embodiment, head-mounted device 100 may be configured to receive wired data including video data via a wired communication channel. In one embodiment, head-mounted device 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

In the illustrated implementation of FIG. 1A, head-mounted device 100 includes a camera 147. Camera 147 is illustrated as a front-facing camera in FIG. 1A, although cameras described in the disclosure may be oriented to capture images from alternative perspectives. Head-mounted device 100 may include more than one camera that include the camera protection features described herein.

Camera 147 may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band.

FIG. 1B illustrates a zoomed in view of exposed camera 147 that is protruding out from a frame 114 of head-mounted device 100. Camera 147 may protrude out from frame 114 approximately 1 mm, in some implementations. Camera 147 may protrude out from frame 114 less than 1 mm, in some implementations. While camera 147 is illustrated as protruding from a frame of a head-mounted device, the camera(s) described in this disclosure may also be included in watches, earbuds, headphones, smartphones, tablets, and/or wearables.

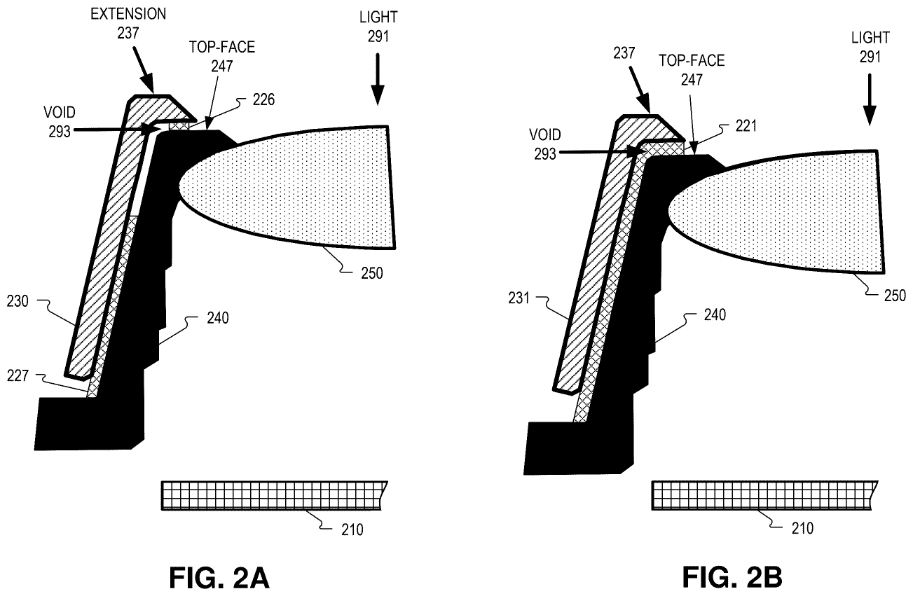

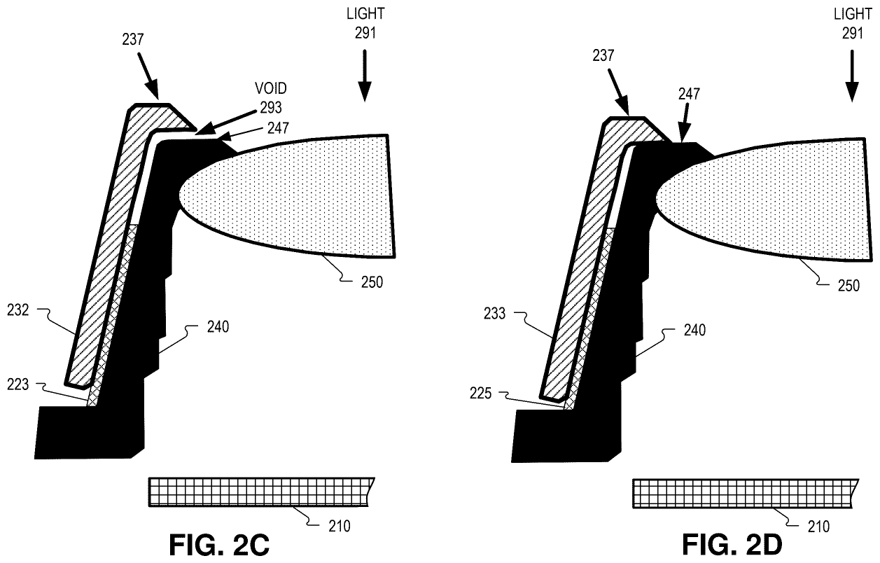

FIG. 2A illustrates a partial side view of lens 250 configured to focus image light 291 to an image sensor 210 and a lens barrel 240 securing the lens 250, in accordance with aspects of the disclosure. Sheath 230 surrounds the lens barrel 240. Sheath 230 is adhered to a side of the lens barrel 240 with a stronger glue 227 and sheath 230 is adhered to a top of the lens barrel 240 with a softer glue 226. Sheath 230 extends at least partially over top-face 247 of lens barrel 240. Void 293 separates top-face 247 of lens barrel 240 and an extension portion 237 of sheath 230. The first glue (stronger glue 227) may have a higher modulus than the second glue (softer glue 226). The top glue (softer glue 226) may have a modulus of between 50 MPa to 1000 MPa, when cured. The side glue (stronger glue 227) may have a modulus of between 300 MPa to 8000 MPa, when cured. In an implementation, the modulus ratio between the side glue 217 and the top glue 226 is between two and eight. The softer glue 226 may be advantageous to place at the top-face 247 of lens barrel 240 compared to the harder glue 227 in order to dampen the impact caused if sheath 230 absorbs a large force (e.g. due to drop event).

Sheath 230 may be a metal sheath. Sheath 230 may be rotationally symmetric around an optical axis of a lens assembly that includes lens 250 and lens barrel 240. Sheath 230 may be formed out of a contiguous piece of metal. Sheath 230 may provide dampening functionality to protect a camera module from impacts. Sheath 230 may also provide a mechanical barrier to keep outside contaminants away from lens barrel 240 that may be more susceptible to environment hazards such as ultraviolet protection or degradation from contaminants (e.g. lotions or sunscreen). In implementations, the metal sleeve color can be a single color or it can have a region of cosmetic color (outer side) and an inner region of low reflection color (e.g. black) to enhance camera performance. A color layer may be disposed over a metal layer of the sheath. For example, the metal layer of sheath 230 may be painted. Additional features of sheath 230 will be described below.

FIG. 2B illustrates a partial side view of lens 250 configured to focus image light 291 to an image sensor 210 and a lens barrel 240 securing the lens 250, in accordance with aspects of the disclosure. Sheath 231 surrounds the lens barrel 240. Sheath 231 is adhered to a side of the lens barrel 240 and a top-face 247 of lens barrel 240 with glue 221. Glue 221 is illustrated as extending contiguously from the side of lens barrel 240 up over the top-face 247 lens barrel 240. Sheath 231 extends at least partially over top-face 247 of lens barrel 240. Void 293 separates top-face 247 of lens barrel 240 and an extension portion 237 of sheath 231.

FIG. 2C illustrates a partial side view of lens 250 configured to focus image light 291 to image sensor 210 and a lens barrel 240 securing the lens 250, in accordance with aspects of the disclosure. Sheath 232 surrounds the lens barrel 240. Sheath 232 is adhered to a side of the lens barrel 240 with glue 223. Top-face 247 of lens barrel 240 is unadhered to extension portion 237 of sheath 232 and a void 293 separates top-face 247 of lens barrel 240 and extension portion 237. In the implementation of FIG. 2C, the void 293 may provide an airgap that allows sheath 232 to flex to provide spring functionality and thus dampen forces from a drop event translating to lens barrel 240.

FIG. 2D illustrates a partial side view of lens 250 configured to focus image light 291 to an image sensor 210 and a lens barrel 240 securing the lens 250, in accordance with aspects of the disclosure. Sheath 233 surrounds the lens barrel 240. Sheath 233 is adhered to a side of the lens barrel 240 with glue 225. Top-face 247 of lens barrel 240 is unadhered to extension portion 237 of sheath 233 and the top-face 247 contacts extension portion 237 of sheath 233. In some cases, the glue 225 might or might not overflow to the base of lens barrel 240.

In the implementations of FIGS. 2A-2D, the glue may be applied to only a portion of the lens barrel. For example, in some implementations, three dots of glue are used around the barrel (rather than 360 degree glue coverage) to secure the sheath to the lens barrel.

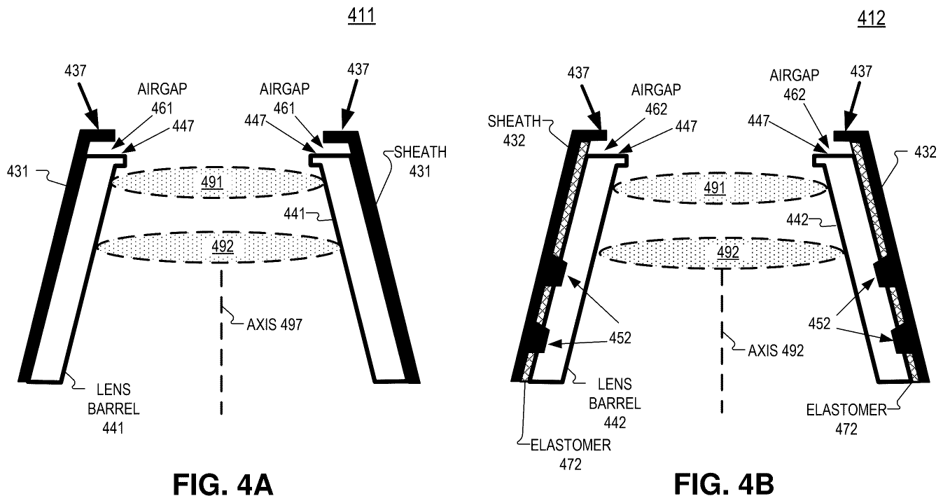

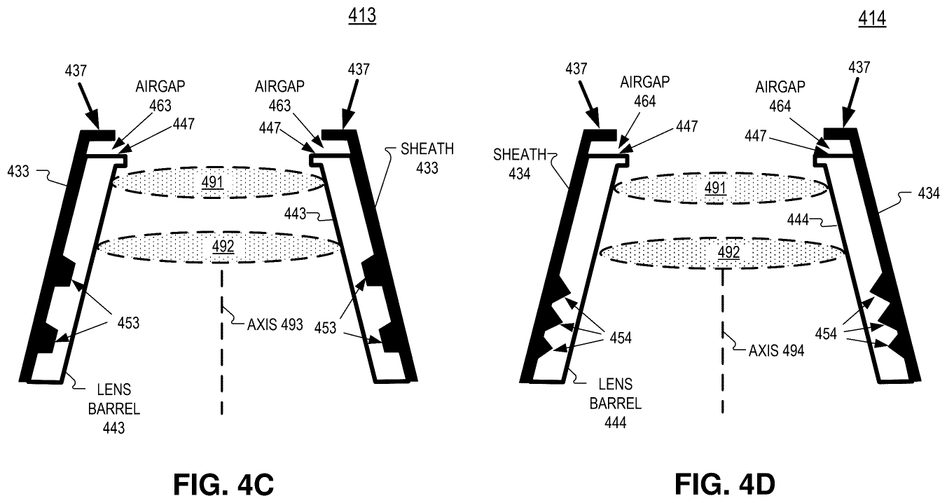

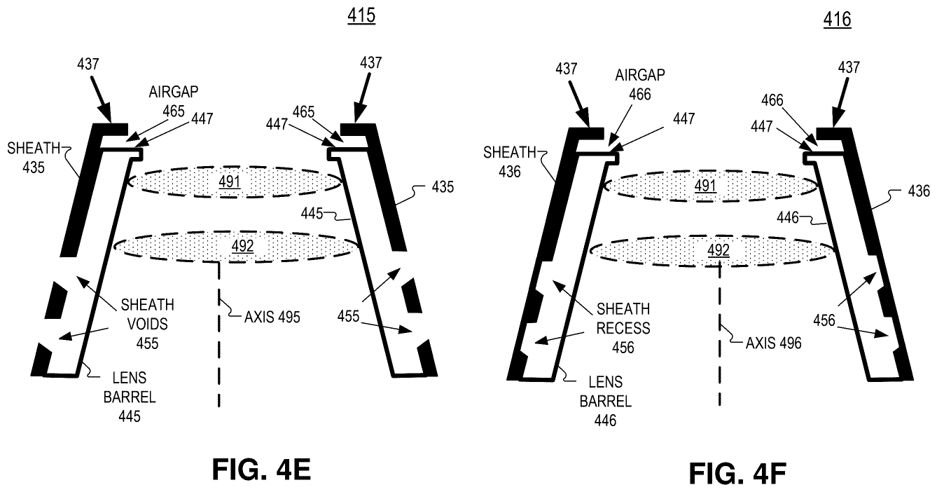

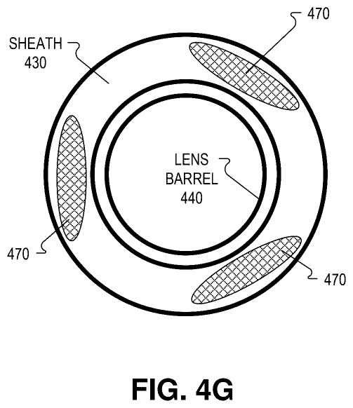

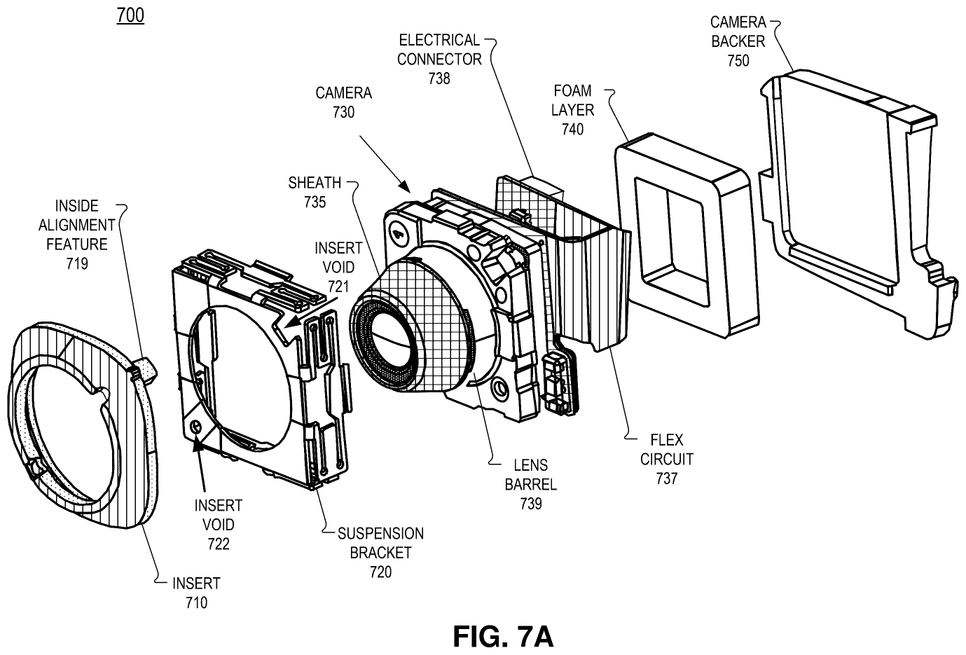

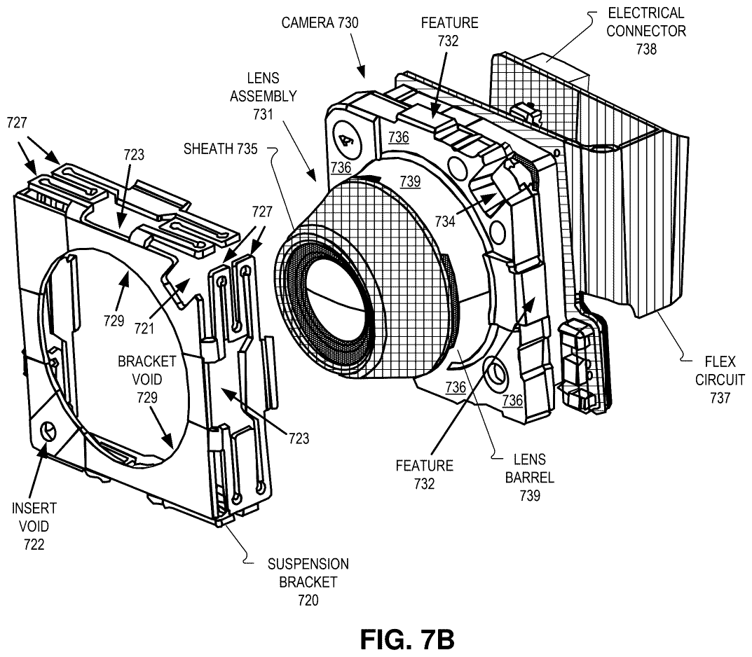

Implementations that include metal sheaths can be utilized for fixed focus cameras as well as autofocus cameras in the same manner as illustrated in FIGS. 2A-2D, 4A-4F, and/or FIGS. 7A-7B. The autofocus cameras may or may not have image stabilization. The autofocus mechanism may be a voice coil motor (VCM), a tunable optics such as a liquid lens, a polymer lens, or other autofocus (AF) technology.

In an implementation, a device includes an outside structure including a void, a voice coil motor (VCM) for autofocus, an image sensor, a thermoplastic lens barrel, a sheath, and a passivation layer. The thermoplastic lens barrel extends through the void and is exposed to an outside environment of the device. The thermoplastic lens barrel is configured to secure one or more lenses that focus image light to the image sensor. The sheath surrounds the thermoplastic lens barrel. The passivation layer is coated on selective parts of the thermoplastic lens barrel. The passivation layer protects exposed parts of the thermoplastic lens barrel from the external contaminants.

In an implementation, a device includes an outside structure including a void, a tunable optical lens element for autofocus, an image sensor, a thermoplastic lens barrel, a sheath, and a passivation layer. The thermoplastic lens barrel extends through the void and is exposed to an outside environment of the device. The thermoplastic lens barrel is configured to secure one or more lenses that focus image light to the image sensor. The sheath surrounds the thermoplastic lens barrel. The passivation layer is coated on selective parts of the thermoplastic lens barrel. The passivation layer protects exposed parts of the thermoplastic lens barrel from the external contaminants.

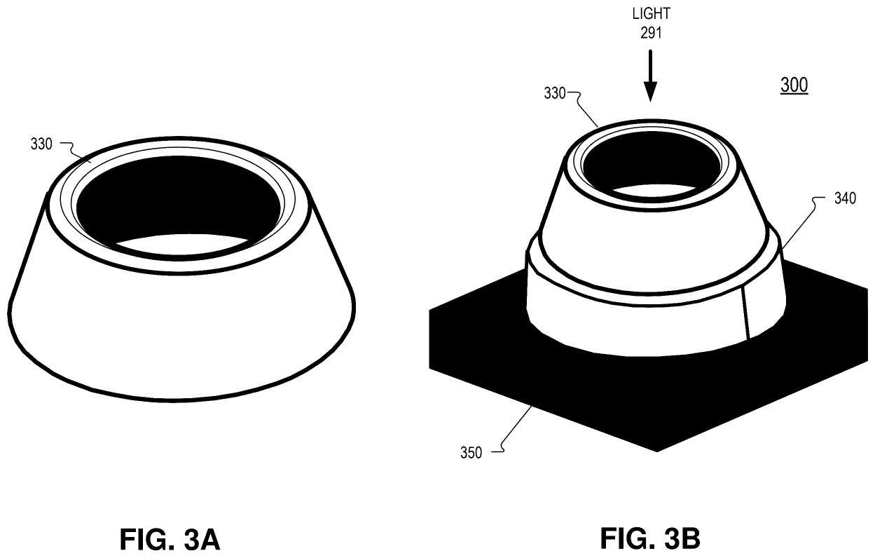

FIG. 3A illustrates an example sheath 330, in accordance with aspects of the disclosure. Sheath 330 may be metal. Sheath 330 may be metal with a protective coating layered over the metal. Sheath 330 may have the geometry of a partitioned cone.

FIG. 3B illustrates an example camera module 300 including sheath 330 glued to a lens barrel 340 that secures one or more lenses configured to focus image light to an image sensor in the black base 350 of the camera module 300, in accordance with aspects of the disclosure. Sheath 330 may protect lens barrel 340 from both drop impacts and from contaminants in the external environment. Sheath 330 may protrude from a frame of a device and be more exposed to contaminants and more likely to receive an impact from a drop event.

FIG. 4A illustrates a portion of a camera module 411 that includes a lens barrel 441 molded to a sheath 431, in accordance with aspects of the disclosure. An airgap void 461 is disposed between sheath 431 and lens barrel 441. Airgap void 461 may allow extension portion 437 to provide spring functionality that dampens impact received from a drop event that contacts sheath 431 while not transferring the force of the impact directly to lens barrel 441. Sheath 431 extends at least partially over top-face 447 of lens barrel 441. Airgap void 461 separates top-face 447 of lens barrel 441 and an extension portion 437 of sheath 431.

Lens barrel 441 is illustrated as securing lenses 491 and 492 that may focus image light to an image sensor (not specifically illustrated) of a fixed focus or autofocus camera along optical axis 497. Sheath 431 may surround at least a portion of lens barrel 441, in some implementations. Lens barrel 441 may extend downward past sheath 431 so that sheath 431 only covers a top portion of lens barrel 441—similarly to the illustration of FIG. 3B. Lens barrel 441 may secure more than two lenses and may also secure filters and/or coverglass (not particularly illustrated). Lens barrel 441 is molded to sheath 431 in a fabrication process that may save on assembly steps of camera module 411.

FIG. 4B illustrates a portion of a camera module 412 that includes a lens barrel 442, a sheath 432, and elastomer layer 472, in accordance with aspects of the disclosure. An airgap void 462 is disposed between sheath 432 and lens barrel 442. Airgap void 462 may allow extension portion 437 to provide spring functionality that dampens impact received from a drop event that contacts sheath 432 while not transferring the force of the impact directly to lens barrel 442. Sheath 432 extends at least partially over top-face 447 of lens barrel 442. Airgap void 462 separates top-face 447 of lens barrel 442 and an extension portion 437 of sheath 432.

Lens barrel 442 is illustrated as securing lenses 491 and 492 that may focus image light to an image sensor (not specifically illustrated) along optical axis 492. Sheath 432 may surround at least a portion of lens barrel 442, in some implementations. Lens barrel 442 may extend downward past sheath 432 so that sheath 432 only covers a top portion of lens barrel 442—similarly to the illustration of FIG. 3B. Lens barrel 442 may secure more than two lenses and may also secure filters and/or coverglass (not particularly illustrated).

Elastomer layer 472 is disposed between the side of the lens barrel 442 and sheath 432. Elastomer layer 472 is molded to sheath 432. Lens barrel 442 is molded to elastomer layer 472. In a fabrication process, elastomer layer 472 may be molded to sheath 432 in a first-shot molding process and lens barrel 442 may be molded to elastomer layer 472 in a second-shot molding process. In some implementations, lens barrel 442 is molded to both the elastomer layer 472 and features 452 of sheath 432 in the second-shot of the molding process. Lens barrel 442 is molded to sheath 432 in a fabrication process that may save on assembly steps of camera module 412.

FIG. 4C illustrates a portion of a camera module 413 that includes a lens barrel 443 molded to a sheath 433 that includes features 453, in accordance with aspects of the disclosure. An airgap void 463 is disposed between sheath 433 and lens barrel 443. Airgap void 463 may allow extension portion 437 to provide spring functionality that dampens impact received from a drop event that contacts sheath 433 while not transferring the force of the impact directly to lens barrel 443. Sheath 433 extends at least partially over top-face 447 of lens barrel 443. Airgap void 463 separates top-face 447 of lens barrel 443 and an extension portion 437 of sheath 433.

Lens barrel 443 is illustrated as securing lenses 491 and 492 that may focus image light to an image sensor (not specifically illustrated) along optical axis 493. Sheath 433 may surround at least a portion of lens barrel 443, in some implementations. Lens barrel 443 may extend downward past sheath 433 so that sheath 433 only covers a top portion of lens barrel 443—similarly to the illustration of FIG. 3B. Lens barrel 443 may secure more than two lenses and may also secure filters and/or coverglass (not particularly illustrated).

One difference between camera module 413 and camera module 412 is that camera module 412 includes an elastomer layer 472 between the lens barrel and the sheath while camera module 413 does not include an elastomer layer between the lens barrel and the sheath. Features 452 and 453 may be described as notches on the inside wall of sheaths 432 and 433, respectively.

FIG. 4D illustrates a portion of a camera module 414 that includes a lens barrel 444 molded to a sheath 434 that includes features 454 that are considered threads disposed on the inside wall of sheath 434, in accordance with aspects of the disclosure. An airgap void 464 is disposed between sheath 434 and lens barrel 444. Airgap void 464 may allow extension portion 437 to provide spring functionality that dampens impact received from a drop event that contacts sheath 434 while not transferring the force of the impact directly to lens barrel 444. Sheath 434 extends at least partially over top-face 447 of lens barrel 444. Airgap void 464 separates top-face 447 of lens barrel 444 and an extension portion 437 of sheath 434.

Lens barrel 444 is illustrated as securing lenses 491 and 492 that may focus image light to an image sensor (not specifically illustrated) along optical axis 494. Sheath 434 may surround at least a portion of lens barrel 444, in some implementations. Lens barrel 444 may extend downward past sheath 434 so that sheath 434 only covers a top portion of lens barrel 444—similarly to the illustration of FIG. 3B. Lens barrel 444 may secure more than two lenses and may also secure filters and/or coverglass (not particularly illustrated).

Threads of features 454 and notches of features 452 and 453 may be considered impact distribution features configured to distribute impact received by the respective sheaths downward around the respective lens barrel. In addition, the lens barrels may be molded to the impact distribution features which may increase the bonding surface area (for the molding process) between the lens barrels and the sheaths.

FIGS. 4E and 4F illustrate features 455 and 456 that may also function as impact distribution features to distribute impact received by the respective sheaths downward around the respective lens barrel, in accordance with aspects of the disclosure. In addition, the lens barrels may be molded to the impact distribution features (e.g. features 455 or 456) which may increase the bonding surface area (for the molding process) between the lens barrels and the sheaths.

In FIG. 4E, features 455 are voids in sheath 435 that penetrates through sheath 435, in accordance with aspects of the disclosure. Features 455 may be formed as vents rather than concentric rings in order to allow sheath 435 to remain a one-piece part. In other words, the voids of feature 455 may not extend all the way around sheath 435. Rather, the voids 455 may extend slightly less than half way around sheath 435 or slightly less than one third around sheath 435, for example.

FIG. 4E illustrates a portion of a camera module 415 that includes a lens barrel 445 molded to a sheath 435 that includes features 455, in accordance with aspects of the disclosure. An airgap void 465 is disposed between sheath 435 and lens barrel 445. Airgap void 465 may allow extension portion 437 to provide spring functionality that dampens impact received from a drop event that contacts sheath 435 while not transferring the force of the impact directly to lens barrel 445. Sheath 435 extends at least partially over top-face 447 of lens barrel 445. Airgap void 465 separates top-face 447 of lens barrel 445 and an extension portion 437 of sheath 435.

Lens barrel 445 is illustrated as securing lenses 491 and 492 that may focus image light to an image sensor (not specifically illustrated) along optical axis 495. Sheath 435 may surround at least a portion of lens barrel 445, in some implementations. Lens barrel 445 may extend downward past sheath 435 so that sheath 435 only covers a top portion of lens barrel 445—similarly to the illustration of FIG. 3B. Lens barrel 445 may secure more than two lenses and may also secure filters and/or coverglass (not particularly illustrated).

In FIG. 4F, features 456 are recesses in sheath 436 that don't penetrate through sheath 436. Features 456 may extend partially around sheath 436 or extend all the way around sheath 436.

FIG. 4F illustrates a portion of a camera module 416 that includes a lens barrel 446 molded to a sheath 436 that includes features 456, in accordance with aspects of the disclosure. An airgap void 466 is disposed between sheath 436 and lens barrel 446. Airgap void 466 may allow extension portion 437 to provide spring functionality that dampens impact received from a drop event that contacts sheath 436 while not transferring the force of the impact directly to lens barrel 446. Sheath 436 extends at least partially over top-face 447 of lens barrel 446. Airgap void 466 separates top-face 447 of lens barrel 446 and an extension portion 437 of sheath 436.

Lens barrel 446 is illustrated as securing lenses 491 and 492 that may focus image light to an image sensor (not specifically illustrated) along optical axis 496. Sheath 436 may surround at least a portion of lens barrel 446, in some implementations. Lens barrel 446 may extend downward past sheath 436 so that sheath 436 only covers a top portion of lens barrel 446—similarly to the illustration of FIG. 3B. Lens barrel 446 may secure more than two lenses and may also secure filters and/or coverglass (not particularly illustrated).

FIG. 4G illustrates a top view of an example adhesive placement with respect to a sheath 430 and lens barrel 440, in accordance with aspects of the disclosure. FIG. 4G shows an example placement of the elastomer layer 472 of FIG. 4B and of possible glue placement of the glue deposits illustrated in FIG. 2A-2D.

In FIG. 4G adhesive 470 bonds sheath 430 to lens barrel 440. Elastomer layer 472 of FIG. 4B and glues 227, 221, 223, and 225 of FIGS. 2A-2D may be placed similarly to adhesive 470 in FIG. 4G. FIG. 4G shows three adhesive deposits 470 that may expand to be an ellipse. The three adhesive deposits 470 may be distributed approximately 120 degrees from each other, in some implementations. In some implementations, there are more than three adhesive deposits. In some implementations, there are two adhesive deposits placed approximately 180 degrees apart. In some implementations, the adhesive deposits are vertical stripes. In some implementations, the coverage of the adhesive deposits is less than 50% of the lens barrel 440. Placing adhesives deposits with various spacings may provide flexibility to sheath 430 and/or lens barrel 440 during drop events and/or thermal expansion and contraction.

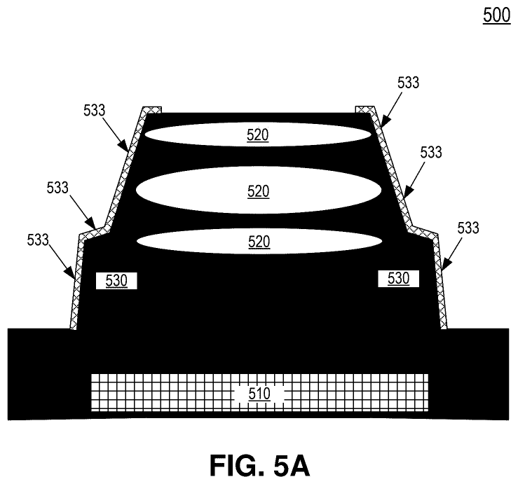

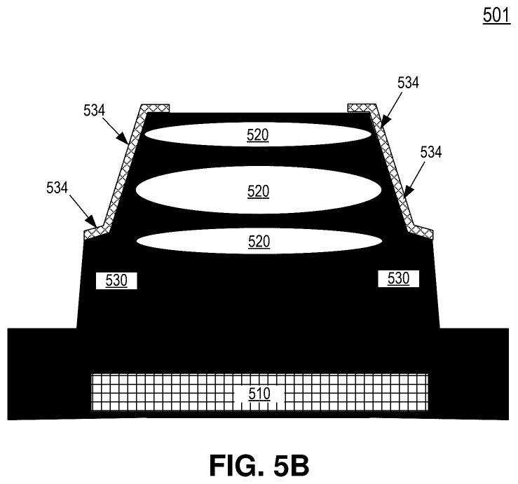

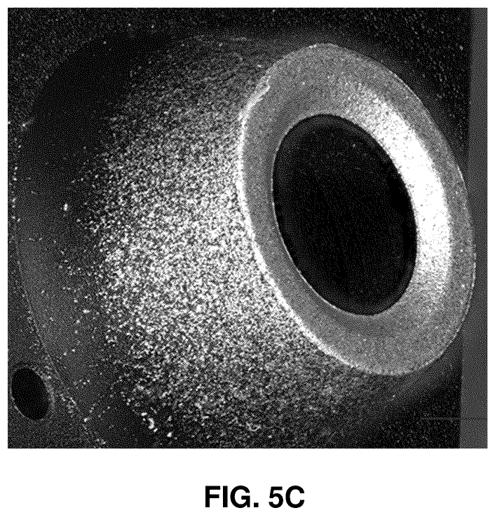

FIG. 5A illustrates a camera module 500 including an image sensor 510 and a polycarbonate lens barrel 530 configured to secure one or more lenses 520 to focus image light to image sensor 510, in accordance with aspects of the disclosure. A passivation layer 533 is coated on the outside of the polycarbonate lens barrel 530 to protect the polycarbonate lens barrel 530 from external chemicals. In some implementations, the thickness of passivation layer 533 is 15-30 microns.

A variety of different materials may be used as passivation layer 533. In implementations of the disclosure, a thin coating from a metal, metal oxide, or organic layer is used as a passivation layer 533 on the lens barrel 530. PC or any other polymer barrel material can be protected by this passivation layer 533. The passivation layer 533 can be applied by physical vapor deposition (PVD), chemical vapor deposition (CVD), or atomic layer deposition (ALD) methods. Application of paint, hardcoat material, and/or anti-fingerprint or anti-smudge coating by traditional methods on the PC can also serve as a protection layer to reduce swelling and reduce or eliminate cracking and improve the cleanability of the surface. Furthermore, application of Parylene or other organic materials either in their monomer form or polymer form by PVD/CVD/ALD, or plasma jetting can be used to provide such a functional coating. In some cases, more than one layer can be used for example SiO₂+Anti-Fingerprint (AF) or Atomic Layer Deposition of Al₂O₃+Parylene.

In an implementation, camera module 500 fits into a device that includes an outside structure including a recess. The recess may be an ellipse. The outside structure may be frame 114, for example. A thermoplastic lens barrel (e.g. lens barrel 530) extends through the recess and is exposed to an outside environment of the device, in some implementations. The thermoplastic lens barrel is configured to secure one or more lens (e.g. lenses 520) that focus image light to an image sensor (e.g. image sensor 510). A sheath may surround the thermoplastic lens barrel. The sheath may include any of the features described with respect to FIGS. 2A-4F. A passivation layer (e.g. passivation layer 533) is coated on selective parts of the thermoplastic lens barrel. The passivation layer protects exposed parts of the thermoplastic lens barrel from external chemicals.

FIG. 5B illustrates a camera module 501 where passivation layer 534 is disposed on a top portion of lens barrel 530 and on a portion of the sides of lens barrel 530, but the passivation layer 534 does not cover the entire lens barrel 530. Passivation layer 534 may only cover the top portion of lens barrel 530 that is exposed to the external environment and thus is more susceptible to external conditions (e.g. ultraviolet light) and external contaminants.

FIG. 5C is an image of a lens barrel that is partially covered by a passivation layer (e.g. paint), in accordance with aspects of the disclosure. Depending on the passivation layer, different techniques may be utilized in a fabrication process to dispose the passivation layer. A color layer may be added to the passivation layer or the color layer over the sheath may serve as the passivation layer. The thickness of the coloring on a lens metal sheath surface may be between 0.005 microns and 100 microns. In implementations of the disclosure, a metal sheath may be manufactured using a lathe, a Swiss lathe, Computer Numerical Control (CNC), stamping, hot forging, or metal injection molding.

The disclosed metal sheath designs would (1) significantly enhance the lens survivability when device/lens drops to the lens edges; (2) optionally create a gap between the sheath and lens barrel; and (3) assist adhesive compliance and patterns between the sheath and the exterior of the lens barrel. Additionally, a metal sheath may provide color design choices.

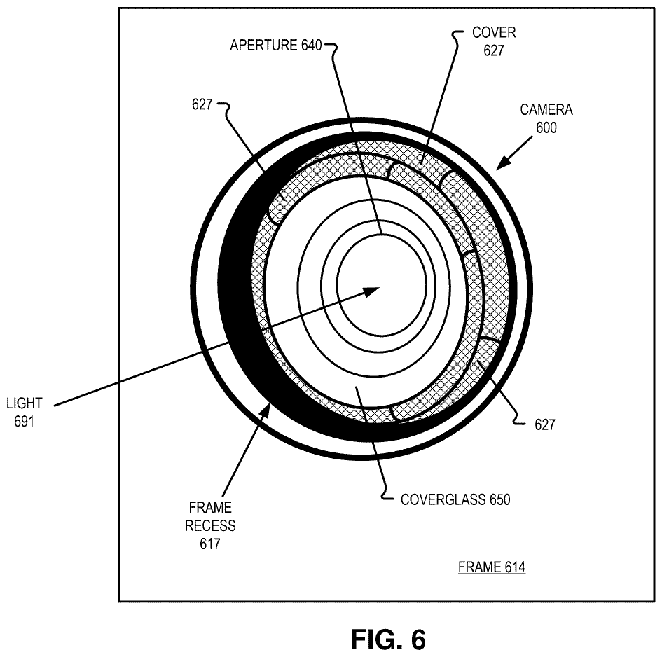

FIGS. 6-9C describe a soft-mounted camera module, in accordance with aspects of the disclosure. FIG. 6 illustrates a frame 614 and a portion of a camera 600 situated in a frame recess 617. Frame 614 may be a frame of an electronic device. Frame 614 may be a frame of a wearable device, for example. Frame 614 may be a frame 114 of head-mounted device 100. Example camera 600 includes cover 627. Cover 627 may be a metal sheath. Cover 627 may be a sheath and include the features of the sheaths described with respect to descriptions of previous Figures of the disclosure. Example camera 600 includes coverglass 650 and an aperture 640. Image light 691 propagates through coverglass 650 and through aperture 640 to become incident on an image sensor of camera 600.

FIG. 7A illustrates an exploded view of an example camera module 700 that dampens the force of impacts sustained by camera module 700, in accordance with aspects of the disclosure. Camera module 700 includes insert 710, suspension bracket 720, camera 730, foam layer 740, and camera backer 750.

Insert 710 may serve to align camera module 700 to a frame of a device (e.g. a frame of a wearable). Suspension bracket 720 is configured to provide soft-mount functionality. An inside alignment feature of insert 710 may assist in aligning insert 710 to suspension bracket 720 by way of an insert void 721 of suspension bracket 720. Insert void 722 of suspension bracket 720 may further align insert 710 to suspension bracket 720. Suspension bracket 720 is coupled to insert 710 when camera module 700 is fully assembled.

Camera module 700 includes a sheath 735 surrounding and protecting at least a portion of lens barrel 739 of camera 730. Camera 730 includes a flex circuit 737 electrically coupled to provide image signals generated by an image sensor of camera module 700 to an electrical connector 738. Processing logic (e.g. processing logic 107) of an electronic device may be configured to receive the image signals from electrical connector 738 and perform further processing on the image signals. In some implementations, foam layer 740 and camera backer 750 may be disposed between an image sensor of camera 730 and electrical connector 738 when camera module 700 is fully assembled.

To assist in dampening impacts, camera module 700 uses the spring functionality of foam layer 740 and suspension bracket 720. Foam layer 740 provides cushioning and rebound force to push camera module 700 back into its proper position, after a drop event is sustained. Camera 730 is configured to push up against foam layer 740 when the camera 730 is pushed inside the frame. Camera backer 750 provides a fixed position for foam layer 740 to cushion and rebound against. In the illustrated implementation of FIG. 7A, foam layer 740 includes a void in the middle of the foam layer 740.

FIG. 7B illustrates a zoomed-in view of an example suspension bracket 720 and camera 730, in accordance with aspects of the disclosure. FIG. 7B shows that suspension bracket 720 includes serpentine structures 727 on four sides of the suspension bracket 720. The serpentine structures 727 provide spring functionality to absorb an impact load from the frame (e.g. frame 614) in a drop event. In FIG. 7B, bracket void 729 is an ellipse, although it could take on different shapes. At least a portion of lens barrel 739 and sheath 735 fit through bracket void 729 and at least a portion of sheath 735 and lens barrel 739 are configured to freely ingress and egress through bracket void 729 in a drop event that impacts sheath 735. When camera module 700 is fully assembled, suspension bracket 720 is coupled to camera 730 and configured to provide impact absorption by temporarily pushing camera 730 inside the frame when a load of an impact is transferred to the frame.

Suspension bracket 720 may be manufactured by cutting and folding metal. A laser may be used to cut out shapes and voids of suspension bracket 720, in some implementations.

FIG. 7B illustrates camera 730 includes a lens assembly 731 that includes sheath 735 and a lens barrel 739 having a lens barrel flange 736. The lens assembly 731 includes one or more lenses (not particularly illustrated in FIG. 7B) configured to focus image light to an image sensor of camera 730. Lens barrel flange 736 may be integrated with lens barrel 739 in a contiguous material such as polycarbonate. Lens barrel flange 736 includes snap alignment features 732, in FIG. 7B. Snap alignment features 732 may be on all four sides of lens barrel flange 736, in some implementations. Suspension bracket 720 includes four snap features 723 on all four sides of suspension bracket 720. The voids of these snap features 723 are configured to fit over and snap into snap alignment features 732 of lens barrel flange 736 when camera module 700 is fully assembled. Since suspension bracket 720 is coupled to insert 710 and insert 710 is coupled to the frame, the snap features 723 and snap alignment features 732 provide a spring-like coupling between camera 730 and the frame. Thus, in the event of an impact, camera 730 can temporarily retreat back into the frame and the spring functionality of the serpentine structures 727 (combined with the rebounding off of foam layer 740) will push the camera 730 back into the proper position after the impact has been dampened. This effect may be referred to as “soft-mount” functionality for the camera module 700.

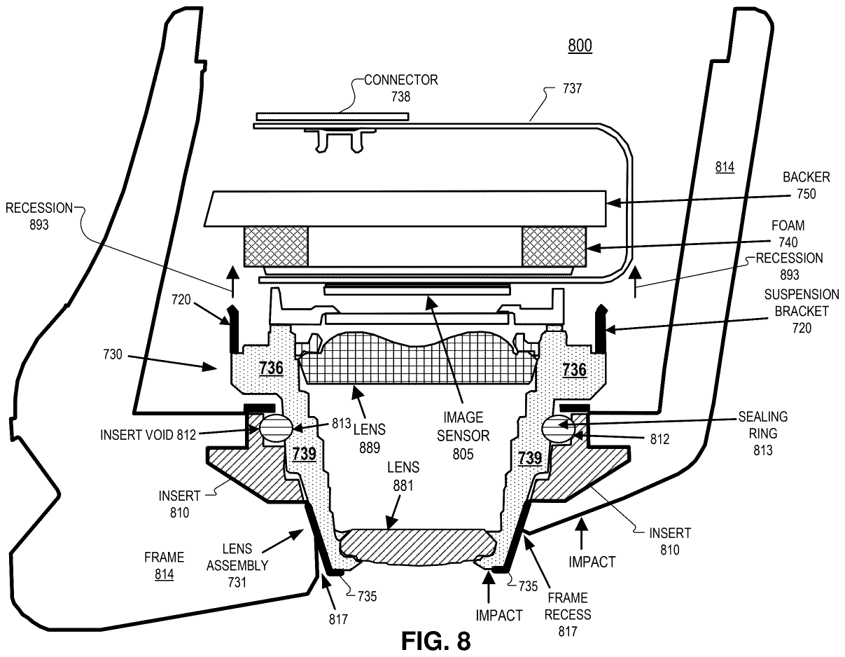

FIG. 8 illustrates an example camera module 800 soft-mounted into a frame 814, in accordance with aspects of the disclosure. FIG. 8 illustrates that an impact on the lens barrel 739 (or optional sheath 735) or an impact on frame 814 may cause the camera 730 to temporarily retreat into frame 814 by a recession distance 893. The suspension bracket 720 being coupled to the lens barrel flange 736 via the snap alignment features 732 and the snap feature voids 723 allows camera 730 to travel into frame 814 until eventually being pulled back to its soft-mount position when the serpentine structures 727 pull the camera 730 back toward the frame.

FIG. 8 illustrates that lens barrel 739 may be configured to secure one or more lenses 881 and/or 889 to focus image light to image sensor 805. A filter or an image sensor cover element may be disposed between image sensor 805 and lens 889. FIG. 8 includes a sealing ring 813 disposed inside an insert-void 812 of example insert 810. Sealing ring 813 is configured to prevent contaminants from penetrating the frame 814 into camera module 800. The lens assembly 731 ingresses (and egresses) through sealing ring 813 when the camera is temporarily retreating into frame 814 and then returns back to the soft-mount position. Sealing ring 813 may be a silicone o-ring, in some implementations. Sealing ring 813 is configured to prevent contaminants (including liquids) from entering into frame 814 even when the camera is temporarily retreating into the frame 814.

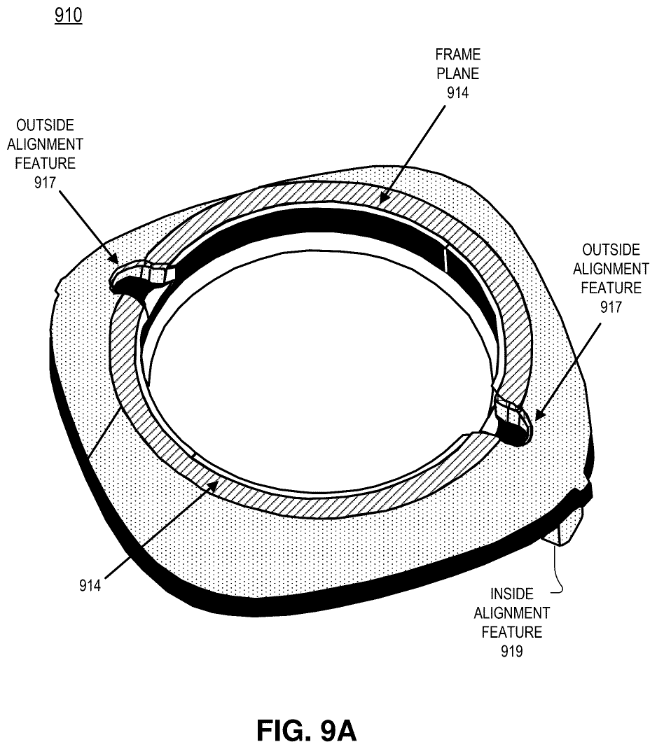

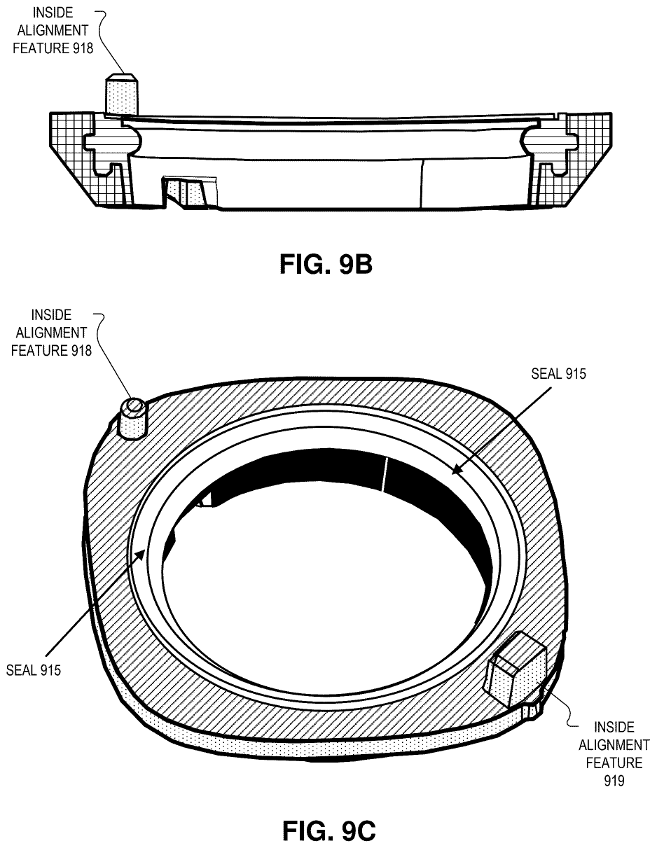

FIG. 9A illustrates a top-perspective view of an example insert 910 that includes a frame plane 914 and alignment features, in accordance with aspects of the disclosure. Frame plane 914 is configured to align the insert 910 to a z-plane of the frame 114/814 during assembly. Insert 910 is fixed to frame 114/814. Outside alignment features 917 are configured to rotationally align insert 910 to the frame. Outside alignment features 917 may be considered notches. In FIG. 9A, the notches of outside alignment features 917 extend through frame plane 914. Inside alignment feature(s) 919 are configured to align insert 910 with the suspension bracket 720.

FIG. 9B illustrates a side view of insert 910, in accordance with aspects of the disclosure.

FIG. 9C illustrates a bottom-perspective view of example insert 910 that includes an overmolded seal 915. Instead of an o-ring, a seal 915 may be overmolded onto insert 910. Overmolded seal 915 is configured to prevent contaminants (including liquids) from entering into frame 814 even when the camera is temporarily retreating into the frame 814. FIG. 9C illustrates an example inside alignment feature 918 and example inside alignment feature 919. Inside alignment feature 918 may be configured to be inserted into void 722 of FIG. 7A and inside alignment feature 919 may be configured to be inserted into void 721 to align insert 910 with suspension bracket 720.

In some implementations, insert 910 is formed and then seal 915 is overmolded onto insert 910. Then, the suspension bracket 720 may be laser welded to the insert 910. After the suspension bracket is coupled to the insert 910, that part may be snapped to features 732 of camera 730 by way of features 723 of suspension bracket 720. The foam layer 740 and camera backer 750 can then be placed in position, as shown in FIG. 8.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera assembly comprising:
a lens configured to focus image light to an image sensor;
a lens barrel securing the lens; and
a metal sheath surrounding the lens barrel, wherein the metal sheath is coupled to a side of the lens barrel and extends at least partially over a top-face of the lens barrel, wherein a void separates the top-face of the lens barrel and an extension portion of the metal sheath that is disposed over the top-face of the lens barrel.

2. The camera assembly of claim 1, wherein the void is an airgap between the extension portion of the metal sheath and the top-face of the lens barrel, the extension portion of the metal sheath configured to bend into the void if an impact is received by the extension portion of the metal sheath.

3. The camera assembly of claim 1, wherein the void is at least partially filled with a cushioning material configured to soften an impact received by the extension portion of the metal sheath.

4. The camera assembly of claim 3, wherein the cushioning material includes an adhesive that bonds the lens barrel to the extension portion of the metal sheath.

5. The camera assembly of claim 4, wherein the metal sheath is coupled to the side of the lens barrel with a first glue, and wherein the extension portion of the metal sheath is adhered to the top-face of the lens barrel with a second glue, the first glue having a higher modulus than the second glue.

6. The camera assembly of claim 1, wherein the metal sheath is adhered to the side of the lens barrel and to the top-face of the lens barrel.

7. The camera assembly of claim 1, wherein the metal sheath is adhered to the side of the lens barrel with two or more glue deposits.

8. The camera assembly of claim 1, wherein the side of the lens barrel is molded to the metal sheath.

9. The camera assembly of claim 8, wherein an inside wall of the metal sheath includes impact distribution features configured to distribute impact received by the metal sheath downward around the lens barrel.

10. The camera assembly of claim 9, wherein the lens barrel is molded to the impact distribution features, the impact distribution features increasing a bonding surface area between the lens barrel and the metal sheath.

11. The camera assembly of claim 1 further comprising:
an elastomer layer disposed between the side of the lens barrel and the metal sheath, wherein the elastomer layer is molded to the metal sheath, and wherein the lens barrel is molded to the elastomer layer.

12. A device comprising:
an outside structure including a void;
an image sensor;
a thermoplastic lens barrel extending through the void and being exposed to an outside environment of the device, wherein the thermoplastic lens barrel is configured to secure one or more lenses that focus image light to the image sensor;
a sheath surrounding the thermoplastic lens barrel; and
a passivation layer coated on selective parts of the thermoplastic lens barrel, wherein the passivation layer protects exposed parts of the thermoplastic lens barrel from external chemicals.

13. A camera module comprising:
an insert configured to be aligned with a frame of a device;
a suspension bracket coupled to the insert; and
a camera including an image sensor and a lens assembly including one or more lenses to focus image light to the image sensor, wherein the suspension bracket is coupled to the camera and configured to provide impact absorption by temporarily pushing the camera inside the frame when a load is transferred to the frame.

14. The camera module of claim 13, wherein the suspension bracket provides spring functionality to absorb the load from the frame.

15. The camera module of claim 14, wherein the suspension bracket includes serpentine structures on four sides of the suspension bracket to provide the spring functionality.

16. The camera module of claim 13 further comprising:
a foam layer disposed between the camera and a frame support, wherein the camera is configured push up against the foam layer when the camera is pushed inside the frame.

17. The camera module of claim 13, wherein the lens assembly includes a lens barrel having a lens barrel flange, wherein the suspension bracket includes four snap features that are coupled to four snap alignments of the lens barrel flange.

18. The camera module of claim 13, wherein the suspension bracket has a bracket-void that the lens assembly ingresses through when the camera is temporarily pushed inside the frame.

19. The camera module of claim 13, wherein the insert includes a sealing ring inside an insert-void of the insert, wherein the sealing ring is configured to prevent contaminants from penetrating the frame, and wherein the lens assembly ingresses through the sealing ring when the camera is temporarily pushed inside the frame.

20. The camera module of claim 13, wherein the insert includes:
a frame plane to align the insert to a z-plane of the frame;
outside alignment features to rotationally align the insert to the frame; and
inside alignment features to align the insert with the suspension bracket.
